(19) United States
(12) Patent Application Publication
(10) Pub. No.: US 2010/0209879 A1
(43) Pub. Date: Aug. 19, 2010

(54) COLOR TEST COMPOSITION FOR DENTAL TREATMENT

(75) Inventors: Junji Fukuchi, Kyoto-shi (JP); Keisuke Torii, Kyoto-shi (JP); Noriyuki Negoro, Kyoto-shi (JP)

Correspondence Address: DAY PITNEY LLP, 7 TIMES SQUARE, NEW YORK, NY, 10036-7311, US

(73) Assignee: SHOFU INC., Kyoto-shi (JP)

(21) Appl. No.: 12/640,046

(22) Filed: Dec. 17, 2009

(30) Foreign Application Priority Data
Dec. 18, 2008 (JP) 2008-321984

(51) Int. Cl. A61C 5/08; A61C 19/00; G01N 21/00

(52) U.S. Cl. 433/219; 433/228.1; 436/164

(57) ABSTRACT

A dental tone match checking material is provided that makes possible the elaboration of better esthetics than in the prior art. The present invention is a dental tone match checking material and relates to a dental tone match checking material, wherein the difference (n₁−n₀) between the refractive index n₁ of this material and the refractive index no of the cured product from the dental cement that is checked with the dental tone match checking material is in the range from −0.040 to +0.020.

### BACKGROUND OF THE INVENTION

1. Field of the Invention

The present invention relates to a novel color test composition for dental treatment.

2. Description of the Related Art

Color test composition for dental treatment or dental tone match checking materials are used to check the suitability of the tone of a dental cement (refer to Bulletin 471 of the Ministry of Health, Labour and Welfare, Japan) and are also known as try-in pastes.

Dental cements are used in dental treatments to bond a dental prosthesis, e.g., a crown, bridge, inlay, onlay, veneer, and so forth, to an anchor tooth, and dental tone match checking materials are employed in order to prevent the finished tone after bonding from being different from a desired tone. Thus, in order to determine which tone of a dental cement should be used, the dental prosthetic restoration or its temporary restoration (provisional restoration) is temporarily mounted beforehand on the anchor tooth using, in place of the dental cement, a dental tone match checking material that has been produced to match the tone of the dental cement after it has cured. Inspection of this condition (appearance) then makes it possible to check the suitability of the particular tone of dental cement that is being considered for use. When according to the results of this inspection the desired tone has been obtained, the dental tone match checking material bonded to the restoration is washed off with water and the corresponding dental cement (dental cement that has a tone that corresponds to that of the dental tone match checking material) is then used to carry out final bonding. When, on the other hand, the desired tone has not been obtained, the same checking process is carried out using a dental tone match checking material that corresponds to a dental cement that has a different tone.

The dental cement used is generally selected from among a variety of tones, and the post-bonding esthetics depend on the combination of the polymerization-cured dental cement and the tone exhibited by the prosthetic restoration itself. Thus, in order to obtain a finish that exhibits excellent esthetics, a dental cement must be selected that presents a suitable tone after bonding has been performed. Due to this, the tone of the cured product provided by the candidate dental cement is desirably simulated using a dental tone match checking material that has a tone adjusted to be as close as possible to the tone of the dental cement after the dental cement has undergone polymerization and curing.

Transparent materials such as ceramics, hard resins, and so forth, have in recent years entered into widespread use in the field of esthetic dentistry, while metals have fallen out of use in this field. As a consequence, highly transparent dental cements, or so-called clear types, are also often used to bond dental prosthetic restorations. Since dental cements and dental tone match checking materials are actually used in film thicknesses generally of about 20 to 100 μm, an exceedingly close approach to transparency is obtained when clear-type dental cements and dental tone match checking materials are used. Due to this, when the generation of a desired tone (esthetic) is being sought, there are limitations on the approach of simply bringing the tones of these two materials into proximity.

A variety of materials have been introduced as dental tone match checking materials. An example is a dental tone match checking material comprising a composition that contains 59 to 95 weight parts (a) glycerin, 1 to 30 weight parts of (b) a first filler having an average primary particle diameter of 0.001 to 0.1 μm, and 2 to 40 weight parts of (c) a second filler having an average primary particle diameter of 1 to 20 μm (Japanese Patent Application Publication No. 2007-137851).

However, the dental tone match checking materials introduced to date, while being produced to have a tone in proximity to the corresponding dental cement, nevertheless present subtle differences from the tone of the cured dental cement that is ultimately obtained, and the problem then arises of not necessarily being able to obtain a satisfactory tone (esthetics).

### SUMMARY OF THE INVENTION

Accordingly, the main object of the present invention is to provide a dental tone match checking material that makes it possible to obtain better esthetics than in the prior art.

As a result of extensive and intensive investigations in view of the problems with the prior art, the present inventor discovered that the aforementioned object could be achieved by controlling the refractive index between a dental cement and its dental tone match checking material. The present invention was achieved based on this discovery.

The present invention thus relates to the following color test composition for dental treatment.

1. A color test composition for dental treatment, wherein a difference (n₁−n₀) between the refractive index n₁ of the color test composition and a refractive index n₀ of a cured product obtained from a dental cement whose color corresponds to that of the color test composition is in a range from −0.040 to +0.020.

2. The color test composition for dental treatment according to above 1, comprising (1) at least one hydrophilic component selected from (a) glycerin and (b) polyethylene glycol and (2) (c) a compound having at least one aromatic group.

3. The color test composition for dental treatment according to above 2, comprising a total of 100 weight parts comprising 40 to 95 weight parts of the hydrophilic component and 5 to 60 weight parts of the compound.

4. The color test composition for dental treatment according to above 2 or 3, wherein (c) the compound having at least one aromatic group is at least one selected from aromatic carboxylic acids, esters of aromatic carboxylic acids, and salts of aromatic carboxylic acids.

5. The color test composition for dental treatment according to any of above 2-4, further comprising 1 to 50 weight parts of a (d) polymerizable monomer that contains at least one hydroxyl group, per 100 weight parts of the total of the hydrophilic component and the compound.

6. The color test composition for dental treatment according to above 5, wherein the (d) polymerizable monomer that contains at least one hydroxyl group is 2-hydroxyethyl (meth)acrylate.

7. The color test composition for dental treatment according to any of above 2-6, further comprising 1 to 30 weight parts of a (e) finely particulate filler having an average particle diameter of not more than 0.1 μm, per 100 weight parts of the total of the hydrophilic component and the compound.

8. The color test composition for dental treatment according to any of above 2-7, further comprising 40 to 240 weight parts of (f) a coarsely particulate filler having an average particle diameter of 0.3 to 20 μm, per 100 weight parts of the total of the hydrophilic component and the compound.

9. The color test composition for dental treatment according to any of above 2-8, further comprising a pigment other than the finely particulate filler and coarsely particulate filter.

10. A dental prosthetic restoration kit, containing at least one set comprising the color test composition for dental treatment according to any of above 1-9 paired with a dental cement whose color corresponds to that of the color test composition.

11. A dental tone match checking method of evaluating the suitability of the tone of a cured product obtained from a dental cement that corresponds to a color test composition for dental treatment, by, prior to bonding a dental prosthesis to an anchor tooth with the dental cement, temporarily mounting the dental prosthesis or a temporary restoration thereof on the anchor tooth using the color test composition and inspecting this temporarily mounted condition,

wherein a difference (n₁−n₀) between the refractive index n₁ of the color test composition and a refractive index n₀ of a cured product obtained from the dental cement is in a range from −0.040 to +0.020.

### ADVANTAGES OF THE INVENTION

The material according to the present invention, because its refractive index difference from the cured dental cement is controlled into a prescribed range, enables checking to be performed under conditions that are even nearer to the tone of the final finished cured dental cement. In other words, final bonding of the prosthetic restoration can be carried out in a state that is almost identical to the tone confirmed with the material according to the present invention.

### DESCRIPTION OF THE PREFERRED EMBODIMENTS

### 1. The Color Test Composition for Dental Treatment

The color test composition for dental treatment or dental tone match checking material according to the present invention (the present composition) is characterized in that the difference (n₁−n₀) between the refractive index n₁ of the present composition and the refractive index n₀ of the cured product from the dental cement that corresponds to the present composition for checking is in the range from −0.040 to +0.020.

In order to achieve better esthetics than are provided by the prior art, the present invention does not simply bring the tone of the color test composition into proximity with that of the dental cement; rather, by focusing on the refractive indices of the materials and controlling the refractive index difference into a prescribed range, the present invention makes it possible to more reliably obtain a desired tone.

The “perception of color” generally means to perceive light that has hit a material and been reflected, and the refractive index of the material thus also influences the perception of color. Due to this, even though a tone match checking material is employed that has a tone engineered to be close to that of the cured dental cement, when there is a large difference in the refractive indices of the tone match checking material and cured dental cement, the tone of the prosthetic restoration post-bonding will end up appearing different from the tone when the prosthetic restoration was temporarily tried on the anchor tooth using the tone match checking material. The present invention makes it possible to reduce or extinguish the aforementioned tone difference by controlling the difference (n₁−n₀) between the refractive index n₁ of the color test composition for dental treatment and the refractive index n₀ of the cured dental cement corresponding to the color test composition into the range from −0.040 to +0.020 (preferably −0.020 to +0.010). To date there has been no prior art that has focused on the refractive index, nor has there been prior art in which the refractive index difference is controlled into the aforementioned range.

For example, the refractive index difference is −0.060 even for products corresponding to Japanese Patent Application Publication No. 2007-137851. The difference between this value and the lower limit of −0.040 for the refractive index difference for the present composition is 0.020, and this difference has a major effect on the appearance (esthetics) of the actual finished condition.

As a general matter, a color test composition for dental treatment or tone match checking material is matched to the tone of the cured product of the dental cement that is checked with the color test composition and is provided in a set paired with its corresponding dental cement. Accordingly, a reference to a dental tone match checking material unambiguously establishes its corresponding dental cement. The refractive index n₀ of the cured dental cement is not limited, but is generally 1.4600 to 1.5800.

The previously described refractive index difference for the color test composition for dental treatment of the present invention should be controlled to −0.040 to +0.020, and the components of this color test composition may also be a combination of components used in prior products. In particular, by using a color test composition according to claim 1 and comprising (1) at least one hydrophilic component selected from (a) glycerin and (b) polyethylene glycol and (2) a (c) compound that contains at least one aromatic group, the present invention can provide a more reliable control to a desired refractive index while maintaining the properties of a color test composition. These components and optional components are described in the following.

(a) Glycerin

Glycerin is a hydrophilic component in the dental tone match checking material of the present invention. Thus, because glycerin is a highly hydrophilic substance, it is used in particular in order to further raise the capacity of the present composition to be washed out with water. The glycerin used here can be a commercial product or can be obtained by a known method of production.

(b) Polyethylene Glycol

Like glycerin, polyethylene glycol is a hydrophilic component in the dental tone match checking material of the present invention. The polyethylene glycol, because it is a highly hydrophilic substance like the previously described component (a), is used in particular to further raise the capacity of the present composition to be washed out with water and to further raise the workability of the present composition. Component (a) and component (b) also exhibit an excellent affinity for one another and an excellent workability and water wash-out behavior can also be obtained when the two are used in combination. There are no particular limitations on the type of polyethylene glycol, and commercial products may also be employed. Nor is there a limitation on the molecular weight of the polyethylene glycol, but the use of polyethylene glycol with a molecular weight no greater than 600 and in particular no greater than 400 is preferred from the standpoint of the workability of the present composition. While there is no limitation on the lower limit of the molecular weight, it is generally about 200.

There are no particular limitations on the quantity of use for these hydrophilic components; however, viewed from the standpoint of the role of this component, the quantity of use is preferably from 40 to 100 weight parts, particularly preferably from 50 to 90 weight parts, and more preferably from 55 to 85 weight parts in each 100 weight parts of the total of the hydrophilic component and the below-described aromatic compound.

(c) The Compound that Contains at Least One Aromatic Group

The compound that contains at least one aromatic group (“the aromatic compound”) is used in particular in order to adjust the refractive index of the present composition (in particular to raise the refractive index). This compound should have one or two or more aromatic groups, but is not otherwise limited, and can be exemplified by benzene, toluene, xylene, phenol, benzyl alcohol, benzoic acid, benzyl benzoate, methyl benzoate, ethyl benzoate, propyl benzoate, butyl benzoate, isopentyl benzoate, sodium benzoate, calcium benzoate, salicylic acid, benzyl salicylate, methyl salicylate, ethyl salicylate, phenyl salicylate, phthalic acid, dimethyl phthalate, diethyl phthalate, dibutyl phthalate, isobutyl phthalate, di-n-hexyl phthalate, dioctyl phthalate, di-n-octyl phthalate, dinonyl phthalate, diisononyl phthalate, diisodecyl phthalate, butyl benzyl phthalate, gallic acid, ethyl gallate, n-propyl gallate, ethyl cinnamate, and so forth. A single one of these or two or more may be used.

Among the preceding, the use is preferred in the present invention of at least one selection from aromatic carboxylic acids, the salts of aromatic carboxylic acids, and the esters of aromatic carboxylic acids. For example, at least one selection from (1) benzoic acid, (2) benzoate salts (particularly the salts of benzoic acid with alkali), and (3) the esters of benzoic acid with alcohols having a carbon number of not more than 10, may be more preferably used in the present invention. More specifically, at least one selection from benzoic acid, benzyl benzoate, methyl benzoate, ethyl benzoate, propyl benzoate, butyl benzoate, isopentyl benzoate, sodium benzoate, and calcium benzoate is suitably used (at least one selected from sodium benzoate and benzyl benzoate is most preferred).

There are no particular limitations on the content of the aromatic compound in the present composition; however, viewed from the standpoint of the role of this component, its content is generally preferably 0 to 60 weight parts and particularly preferably is 10 to 50 weight parts in each 100 weight parts of the total of the previously described hydrophilic component and the aforementioned aromatic compound. 15 to 45 weight parts is more preferred.

The color test composition for dental treatment of the present invention may have a composition comprising the hydrophilic component and the compound described hereinabove, but as necessary may also incorporate the following components (d) to (g) as optional components as suitable. The color test composition of the present invention generally assumes a liquid state when it has a composition comprising substantially only the previously described hydrophilic component and aromatic compound, and this case is therefore also referred to in the present invention as the “liquid color test composition”.

(d) Polymerizable Monomer Having at Least One Hydroxyl Group

A polymerizable monomer that contains at least one hydroxyl group is used in order to adjust the affinity with the previously described hydrophilic component and with the previously described aromatic compound and to raise the workability as a dental material.

This polymerizable monomer has at least one hydroxyl group but is not otherwise limited, but as a particular matter at least one selection from acrylic acid, methacrylic acid, and their esters can be suitably used. For example, 2-hydroxyethyl(meth)acrylate is preferred.

There is no particular limitation on its content when the polymerizable monomer that contains at least one hydroxyl group is added to the present composition; however, viewed from the standpoint of the role of this component, its content is generally preferably 1 to 50 weight parts and is particularly preferably 15 to 35 weight parts per 100 weight parts of the liquid dental tone match checking material comprising the aforementioned hydrophilic component and aromatic compound.

(e) The Finely Particulate Filler Having an Average Particle Diameter of not More than 0.1 μm.

The finely particulate filler having an average particle diameter of not more than 0.1 μm is used in order to thicken the present composition and provide an optimal shapeability and thereby provide a highly workable material. It can be also used to adjust the refractive index of the present composition.

Commercial products can be used for this finely particulate filler. Colloidal silica is suitably used when the finely particulate filler is silica. Viewed from the standpoint of the roles set out above, this microparticulate filler should have an average particle diameter generally of not more than 0.1 μm and particularly preferably of about 0.0001 to 0.1 μm and more preferably of 0.001 to 0.08 μm. The average particle diameter referenced in the present invention is the value measured using a laser particle diameter analysis instrument (the PAR-III laser particle analyzer system from Otsuka Electronics Co., Ltd.).

There are no particular limitations on the content of the finely particulate filler in the present composition; however, viewed from the standpoint of the role of this component, its content is generally preferably from 1 to 30 weight parts and particularly preferably is from 5 to 15 weight parts per 100 weight parts of the liquid color test composition comprising the aforementioned hydrophilic component and aromatic compound.

(f) The Coarsely Particulate Filler Having an Average Particle Diameter of 0.5 to 20 μm

The coarsely particulate filler is used in order to provide the same thickness as the coating film thickness provided by the dental cement. Due to this, the coarsely particulate filler has an average particle diameter of 0.5 to 20 μm and preferably 0.5 to 5 μm. There are also no limitations on the particle shape of the coarsely particulate filler, and the particle shape may be, for example, spherical, acicular, plate shaped, scale shaped, crushed, irregular, and so forth. When the average particle diameter of the coarsely particulate filler is less than 0.5 μm, the risk arises that an excellent workability as a color test composition may not be obtained. When the average particle diameter of the coarsely particulate material is larger than 20 μm, an excellent film thickness—as a color test composition for dental treatment—may not be obtained.

The coarsely particulate filler is not limited in regards to type, and one or more selections from known or commercially available inorganic fillers, organic fillers, and organic-inorganic composite fillers can be used.

The inorganic filler can be exemplified by 1) silica; 2) minerals based on silica (kaolin, clay, mica, and the like); 3) silica-type ceramics and silica-type glasses (based on silica and containing, for example, Al₂O₃, B₂O₃, ZrO₂, BaO, La₂O₃, TiO₂, SrO₂, CaO, P₂O₅, and so forth); 4) crystalline quartz; and 5) metal oxides, metal hydroxides, metal salts, and metal fluorides (e.g., hydroxyapatite, alumina, titanium oxide, yttrium oxide, zirconia, calcium phosphate, barium sulfate, aluminum hydroxide, sodium fluoride, potassium fluoride, sodium monofluorophosphate, lithium fluoride, ytterbium fluoride, and so forth). The aforementioned glasses can be exemplified by lanthanum glass, barium glass, strontium glass, soda glass, lithium borosilicate glass, zinc glass, fluoroaluminosilicate glass, borosilicate glass, bioglass, and the like.

The organic filler can be exemplified by polymethyl methacrylate, polyethyl methacrylate, the polymers of multifunctional methacrylates, polyamide, polystyrene, polyvinyl chloride, chloroprene rubber, nitrile rubber, styrene-butadiene rubber, and so forth.

The organic-inorganic composite filler can be exemplified by materials comprising an inorganic filler loaded in an organic polymer. There are no limitations on this inorganic filler, and the inorganic fillers provided above as examples may be used here. Nor are there particular limitations on the method of producing the organic-inorganic fillers, and any known method can be employed for this purpose. Examples are methods in which the surface of the inorganic filler is microcapsulated or grafted with an organic material and methods in which a previously prepared bulk inorganic filler-containing polymer is crushed.

In order to improve the workability of the present composition, a surface treatment may also be executed on the inorganic filler, organic filler, or organic-inorganic composite filler. Known methods can be employed to carry out the surface treatment; for example, the filler surface can be coated with a surface-treatment agent comprising one or two or more selections from known surface-treatment agents such as silane coupling agents, titanate coupling agents, polysiloxanes, surfactants, organic acids (fatty acids), inorganic acids, and so forth. Preferred for use from among the preceding surface-treatment agents are the silane coupling agents commonly used in the field of dentistry. Specific examples are vinyltrimethoxysilane, vinyltriethoxysilane, vinyltrichlorosilane, vinyl(β-methoxyethoxy)silane, γ-methacryloyloxypropyltrimethoxysilane, γ-glycidoxypropyltrimethoxysilane, γ-mercaptopropyltrimethoxysilane, γ-aminopropyltrimethoxysilane, and so forth. γ-methacryloyloxypropyltrimethoxysilane is particularly preferred among the preceding.

In the present invention, the coarsely particulate filler may be only surface-treated filler, or only filler lacking a surface treatment, or a combination of surface-treated filler and filler lacking a surface treatment.

There are no particular limitations on the content of the coarsely particulate filler in the present composition; however, in view of the role of this component, its content is generally preferably 40 to 240 weight parts and particularly preferably 60 to 185 weight parts per 100 weight parts of the liquid color test composition comprising the aforementioned hydrophilic component and aromatic compound. The finely particulate filler (e) may also be added for the purpose of preventing the coarsely particulate filler from sedimenting. There are no particular limitations on the finely particulate filler content for this purpose; however, considering the role of this component, 1 to 30 weight parts is generally preferred and 2 to 12 weight parts is particularly preferred, in each case per 100 weight parts of the liquid color test composition comprising the aforementioned hydrophilic component and aromatic compound.

(g) Other Additives

Other additives may be present in the present composition on an optional basis. For example, colorants (pigments or dyes), solvent (water, water-soluble organic solvents, and so forth), polymerization inhibitors, fluorescent materials, ultraviolet-absorbing substances, and so forth, may be present within a range that does not impair the effects of the present invention.

The present composition can be obtained by mixing components (a) to (g) to uniformity by a known method. For example, stirring and mixing can be carried out using a mixing device such as a mixer, kneader, or the like.

In this case, given that a dental cement will be present that is checked with the present composition, the refractive index of the present composition should be controlled after the refractive index of the cured product obtained from this dental cement has been measured, and the content of the previously described individual components may then be suitably adjusted. Presuming that the refractive indices of the individual components are already known, as a general matter, larger amounts of a high refractive index component may be incorporated in order to raise the refractive index of the present composition, while, conversely, larger amounts of a low refractive index component may be incorporated in order to lower the refractive index. For example, considering the admixture of benzyl benzoate (refractive index n₁=1.568) into polyethylene glycol (refractive index n₁=1.465), the refractive index is raised as the benzyl benzoate content is increased. The refractive index of the present composition can be easily controlled proceeding in this manner.

The present composition is generally provided in the form of a liquid or paste. That is, the present composition is preferably a liquid or paste color test composition.

### 2. The Dental Prosthetic Restoration Kit

The present invention encompasses a dental prosthetic restoration kit that contains at least one set comprising the color test composition for dental treatment according to above paired with a dental cement whose color corresponds to that of the color test composition for dental treatment.

The dental cement itself can be a known dental cement or a commercially available dental cement. For example, a resin cement can be suitably used.

The kit according to the present invention may be only one set of color test composition paired with the dental cement whose color corresponds to that of the color test composition, or may have more than one set of color test composition/dental cement pairs executed in different tones. For example, a kit can be provided that has sets of five differently toned color test compositions and the five corresponding dental cements (a total of 10 products).

### 3. The Dental Tone Match Checking Method

The present invention also encompasses a dental tone match evaluation method of checking the suitability of the tone of a cured product obtained from a dental cement whose color corresponds to that of a color test composition for dental treatment, by, prior to bonding a dental prosthesis to an anchor tooth with the dental cement, temporarily mounting the dental prosthesis or a temporary restoration therefor on the anchor tooth using the color test composition and inspecting this temporarily mounted condition,

wherein the difference (n₁−n₀) between the refractive index n₁ of the color test composition and the refractive index n₀ of the cured product obtained from the dental cement is in a range from −0.040 to +0.020.

The checking method of the present invention can be carried out in the same manner as known checking methods, with the exception that the checking method of the present invention uses a dental cement paired with a dental tone match checking material that exhibits the previously specified refractive index difference.

The color test composition for dental treatment according to 1. above can suitably be used as the dental tone match checking material. In addition, the kit according to 2. above can suitably be used for the set with the dental cement.

There are no limitations on the dental prosthesis, and, for example, crowns, bridges, inlays, onlays, veneers, or the like, can be used. The invention can also be used with temporary restorations (provisional restorations) for these dental prostheses.

The checking method can proceed according to known procedures in conformity with the nature of the dental prostheses. For example, in the case of an esthetic restoration treatment using a laminate veneer, the tooth that is the target of the dental treatment is shaved to form the anchor tooth. Then, the laminate veneer to be bonded to the anchor tooth is prepared while working so as to conform to the shape of the anchor tooth. The laminate veneer is first temporarily mounted on the anchor tooth using the color test composition rather than dental cement. The temporary mounting state (appearance) is inspected and the tone balance and so forth, with the surrounding teeth is observed. When, as a result, the desired tone has been obtained, the laminate veneer is removed from the anchor tooth and the color test composition adhered to the anchor tooth and the laminate veneer is washed off with water. After this, in the final finishing the laminate veneer is bonded to the anchor tooth using the dental cement that is checked with the color test composition and the esthetic prosthetic treatment is thus brought to completion. In this case, known treatments, such as an etching treatment, primer treatment, and so forth, may be preliminarily carried out on the bonding surface (the surface in contact with the anchor tooth) of the laminate veneer prior to bonding.

When the result of observation of the temporary installation is that the desired tone has not been obtained, temporary mounting and inspection of the appearance may be similarly carried out using differently toned color test compositions until the desired tone is obtained.

### EXAMPLES

Examples and comparative examples are given below in order to more specifically describe the characteristic features of the present invention. However, the scope of the present invention is not limited to the examples.

(1) Components Used

The abbreviations for the compounds used in the examples and comparative examples are given below.
G: glycerin
PG: propylene glycol (solvent)
SB: sodium benzoate
BB: benzyl benzoate
2-HEMA: 2-hydroxyethyl methacrylate
PEG400: polyethylene glycol (molecular weight=400)
silica filler: The silica filler was prepared by subjecting 100 weight parts silica microbeads (average particle diameter=3.0 μm) to a surface treatment: with 18 weight parts γ-methacryloxypropyltrimethoxysilane.
glass filler-1: Glass filler-1 was obtained by pulverizing a fluoroaluminosilicate glass in a bead mill to give a glass filler with an average particle diameter of 1.0 μm and then subjecting 100 weight parts of this glass filler to a surface treatment with 18 weight parts 7-methacryloxypropyltrimethoxysilane.
glass filler-2: Glass filler-2 was obtained by pulverizing a fluoroboroaluminosilicate glass in a bead mill to give a glass filler with an average particle diameter of 1.0 μm and then subjecting 100 weight parts of this glass filler to a surface treatment with 18 weight parts γ-methacryloxypropyltrimethoxysilane.
finely particulate silica: Aerosil R972 (from Degussa) with an average particle diameter of 0.016 μm

(2) Evaluation Methods

The methods used to evaluate the dental tone match checking materials provided in the individual examples and comparative examples are given below.

### (Shade Matching Test for Color Test Composition)

A dental resin modeling material (“Shofu Die Color Checker” from Shofu Inc., tone: 7) is filled into a 15 mm×20 mm×2.6 mm mold and a micro coverglass is pressed onto the surface of the filled dental resin modeling material; polymerization and curing are performed by exposing both sides to light for 3 minutes each from a dental photopolymerization tool (“Twin Polymerizer” from Shofu Inc.). The resulting cured article is adjusted to 15 mm×20 mm×2.4 mm and a groove with a depth of 0.1 mm is placed in the surface to give the lower test specimen.

A photopolymerizable hard resin for crowns (“CERAMAGE” from Shofu Inc., tones: T, T-Glass) is filled into a 15 mm×20 mm×2.6 mm mold and a micro coverglass is pressed onto the surface of the filled dental resin modeling material; polymerization and curing are performed by exposing both sides to light for 3 minutes each from a dental photopolymerization tool (“Twin Polymerizer” from Shofu Inc.). The resulting cured article is adjusted to 15 mm×20 mm×1.0 mm and one side is finished to a glossy surface by buffing, thereby giving the upper test specimen.

An appropriate quantity of the prepared dental tone match checking material is coated in the groove of the lower test specimen and the upper test specimen is mounted thereon. The glossy side of the upper test specimen is placed up when this is done. Pressing is performed so as to expand the dental tone match checking material into the entire groove in the lower test specimen (tone match checking test specimen-1). Standard whiteboard is placed behind the tone match checking test specimen-1 and the color (L*1, a*1, b*1) is measured using a light source C and a color measurement viewing angle of 2°. The upper test specimen and lower test specimen are separated and the adhering dental tone match checking material is removed.

An appropriate quantity of a dental bonding resin cement (ResiCem from Shofu Inc., tone: C) is applied in the groove of the lower test specimen and the upper test specimen is mounted thereon. The glossy side of the upper test specimen is placed up when this is done. Pressing is performed so as to expand the dental bonding resin cement into the entire groove in the lower test specimen, and the dental bonding resin cement is polymerized and cured by exposure from above to light for 3 minutes from a dental photopolymerization tool (“Twin Polymerizer” from Shofu Inc.) (tone match checking test specimen-2). Standard whiteboard is placed behind this tone match checking test specimen-2 and the color (L*2, a*2, b*2) is measured using a light source C and a color measurement viewing angle of 2°. The following equation is used to calculate the color difference ΔE* between the dental tone match checking material in a pressed-down condition (tone match test specimen-1) and the dental bonding resin cement in a pressed-down and cured condition (tone match test specimen-2). A spectral colorimeter (CM-2002 from Minolta) was used as the color measurement instrument.

ΔE*={(L*1−L*2)²+(a*1−a*2)²+(b*1−b*2)²}^{1/2}

The performance of the dental tone match checking material as a trial material for the dental bonding resin cement was evaluated based on ΔE*. Smaller values for ΔE* are indicative of a smaller color difference between the dental tone match checking material in a pressed-down condition and the dental bonding resin cement in a pressed-down and cured condition and are indicative of a better performance as a trial material.

Visual checking of the tones of the tone match checking test specimen-1 and the tone match checking test specimen-2 was performed by 10 dentists and dental technicians. Checking was carried out by setting the tone match checking test specimen-1 and tone match checking test specimen-2 side by side on white paper and a gray board for tone checking and visually checking for the presence/absence of a tone difference.

### (Measurement of the Refractive Index)

The refractive index of the dental tone match checking material was measured at 23° C. using an Abbe refractometer (“Abbe Refractometer 2T” from Atago Co., Ltd.). The measurement was performed according to the instructions for use provided with the “Abbe Refractometer 2T”. Each sample was measured twice and the refractive index was determined as the resulting average value.

### Example 1

85 weight parts G and 15 weight parts SB were introduced into a polypropylene vessel and a liquid dental tone match checking material was prepared by mixing with a Turbula mixer.

ΔE* was measured according to the tone match test for dental tone match checking materials using “CERAMAGE” (tone: T-Glass) from Shofu Inc., for the upper test specimen. The result was a small color difference with a ΔE* of 0.340. On a visual basis, 10 of the 10 individuals rendered the judgment that there was no color difference.

The refractive index was measured according to the refractive index measurement method and a value of −0.016 was calculated for the difference (n₁−n₀) from the refractive index of the cured product from the dental bonding resin cement used (ResiCem from Shofu Inc., tone: C).

### Example 2

85.0 weight parts G, 15.0 weight parts SB, and 10.0 weight parts of the finely particulate silica were introduced into a polypropylene vessel and a dental tone match checking material paste containing finely particulate filler was prepared by mixing with a Turbula mixer.

ΔE* was measured according to the tone match test for dental tone match checking materials using “CERAMAGE” (tone: T-Glass) from Shofu Inc., for the upper test specimen. The result was a small color difference with a ΔE* of 0.336. On a visual basis, 10 of the 10 individuals rendered the judgment that there was no color difference.

The refractive index was measured according to the refractive index measurement method and a value of −0.019 was calculated for the difference (n₁−n₀) from the refractive index of the cured product from the dental bonding resin cement used (ResiCem from Shofu Inc., tone: C).

### Example 3

85.0 weight parts G, 15.0 weight parts SB, 66.7 weight parts glass filler-1, and 3.4 weight parts of the finely particulate silica were introduced into a polypropylene vessel and a filler-containing dental tone match checking material paste was prepared by mixing with a Turbula mixer.

ΔE* was measured according to the tone match test for dental tone match checking materials using “CERAMAGE” (tone: T-Glass) from Shofu Inc., for the upper test specimen. The result was a small color difference with a ΔE* of 0.368. On a visual basis, 10 of the 10 individuals rendered the judgment that there was no color difference.

The refractive index was measured according to the refractive index measurement method and a value of −0.016 was calculated for the difference (n₁−n₀) from the refractive index of the cured product from the dental bonding resin cement used (ResiCem from Shofu Inc., tone: C).

### Example 4

44.0 weight parts PEG400, 56.0 weight parts BB, and 25.0 weight parts 2-HEMA were introduced into a polypropylene vessel and a liquid dental tone match checking material was prepared by mixing with a Turbula mixer.

ΔE* was measured according to the tone match test for dental tone match checking materials using “CERAMAGE” (tone: T-Glass) from Shofu Inc., for the upper test specimen. The result was a small color difference with a ΔE* of 0.385. On a visual basis, 10 of the 10 individuals rendered the judgment that there was no color difference.

The refractive index was measured according to the refractive index measurement method and a value of −0.002 was calculated for the difference (n₁−n₀) from the refractive index of the cured product from the dental bonding resin cement used (ResiCem from Shofu Inc., tone: C).

### Comparative Examples 1-4

Dental tone match checking materials were prepared using only water, only PG, only 2-HEMA, and only PEG400.

ΔE* was measured according to the tone match test for dental tone match checking materials using “CERAMAGE” (tone: T-Glass) from Shofu Inc., for the upper test specimen. The results for ΔE* were 1.907 for the water, 0.959 for the PG, 0.769 for the 2-HEMA, and 0.653 for the PEG400, and larger color differences were thus shown than in Example 1. On a visual basis, none of the individuals rendered the judgment that there was no color difference.

The differences (n₁−n₀) from the refractive index of the cured product from the dental bonding resin cement used (ResiCem from Shofu Inc., tone: C) were determined to be −0.176, −0.075, −0.055, and −0.041, respectively, and the refractive index differences (n₁−n₀) were thus larger than in Example 1.

### Examples 5-10

Using the component compositions shown in Table 1, the components were introduced into a polypropylene vessel and the liquid dental tone match checking material was prepared by mixing with a Turbula mixer.

The properties of the obtained liquid dental tone match checking materials were evaluated as in Example 1. According to the results, ΔE* indicated small color differences, while on a visual basis 9 to 10 of the 10 individuals rendered the judgment that there was no color difference. In addition, the refractive index was measured according to the refractive index measurement method and the difference (n₁−n₀) from the refractive index of the cured product from the dental bonding resin cement used (ResiCem from Shofu Inc., tone: C) was calculated. The results of these evaluations are shown in Table 1.

### Comparative Examples 5-7

Using the same components as in Examples 2 to 7 as shown in Table 1 but different incorporation proportions, liquid dental tone match checking materials were produced as in Examples 2 to 7 and the properties were evaluated as in Examples 2 to 7. The results of these evaluations are shown in Table 1.

For each of the compositions in Comparative Examples 5 to 7, the difference (n₁−n₀) from the refractive index of the cured product from the dental bonding resin cement used (ResiCem from Shofu Inc., tone: C) fell outside the range of −0.040 to +0.020, and, when “CERAMAGE” (tone: T-Glass) from Shofu Inc., was used for the upper test specimen, ΔE* showed larger color differences than in Examples 2 to 7 with values at 0.471, 0.461, and 0.474. With regard to the visual checking, the number of individuals rendering a judgment of no color difference was small at 1 individual, 2 individuals, and 1 individual.

### Examples 11-19

Filler-containing dental tone match checking material pastes were produced by introducing a component composition as shown in Table 2 into a polypropylene vessel and mixing with a Turbula mixer.

ΔE* was measured according to the tone match test for dental tone match checking materials using “CERAMAGE” (tones: T and T-Glass) from Shofu Inc., for the upper test specimen. ΔE* showed a small color difference according to the results. On a visual basis, 9 or 10 of the 10 individuals rendered a judgment of no color difference.

The refractive index was measured according to the refractive index measurement method and the difference (n₁−n₀) from the refractive index of the cured product from the dental bonding resin cement used (ResiCem from Shofu Inc., tone: C) was calculated. The results of these evaluations are shown in Table 2.

### Comparative Examples 8-12

Filler-containing dental tone match checking material pastes were produced by introducing a component composition as shown in Table 2 into a polypropylene vessel and mixing with a Turbula mixer. The properties were evaluated as in Examples 8 to 16. The results of these evaluations are shown in Table 3.

For each of the compositions in Comparative Examples 8 to 12, the difference (n₁−n₀) from the refractive index of the cured product from the dental bonding resin cement used (ResiCem from Shofu Inc., tone: C) fell outside the range of −0.040 to +0.020, and, when “CERAMAGE” (tone: T) from Shofu Inc., was used for the upper test specimen, ΔE* showed larger color differences than in Examples 8 to 16 with values at 0.606, 0.519, 1.297, 1.915, and 3.174. With regard to the visual checking, the number of individuals rendering a judgment of no color difference was small at 2 individuals, 1 individual, zero individuals, zero individuals, and zero individuals. When “CERAMAGE” (tone: T-Glass) from Shofu Inc., was used for the upper test specimen, ΔE* showed larger color differences than in Examples 8 to 16 with values at 1.737, 0.833, 0.525, 0.937, and 1.981. With regard to the visual checking, the number of individuals rendering a judgment of no color difference was small at zero individuals, zero individuals, 1 individual, zero individuals, and zero individuals.

TABLE 1
Composition of the dental tone match checking materials (liquids) and evaluation results

| | | | | | ΔE* (upper | number of individuals |
|---|---|---|---|---|---|---|
| | | PEG400 | | | test | rendering a judgment of no |
| | BB (weight | (weight | refractive | | specimen: | color difference in visual |
| | parts) | parts) | index | n₁ − n₀ | T-Glass) | checking by 10 individuals |
| Example 5 | 30.0 | 70.0 | 1.496 | −0.010 | 0.397 | 10 individuals |
| Example 6 | 35.0 | 65.0 | 1.501 | −0.005 | 0.396 | 10 individuals |
| Example 7 | 40.0 | 60.0 | 1.506 | 0 | 0.388 | 10 individuals |
| Example 8 | 45.0 | 55.0 | 1.512 | 0.006 | 0.387 | 10 individuals |
| Example 9 | 50.0 | 50.0 | 1.516 | 0.010 | 0.399 | 10 individuals |
| Example 10 | 55.0 | 45.0 | 1.521 | 0.015 | 0.404 | 9 individuals |
| Comp. Ex. 5 | 65.0 | 35.0 | 1.531 | 0.025 | 0.471 | 1 individual |
| Comp. Ex. 6 | 70.0 | 30.0 | 1.536 | 0.030 | 0.461 | 2 individuals |
| Comp. Ex. 7 | 90.0 | 10.0 | 1.557 | 0.051 | 0.474 | 1 individual |

TABLE 2
Composition (weight parts) of dental tone match checking materials (pastes)

| | | | | | silica | glass | glass | finely particulate |
|---|---|---|---|---|---|---|---|---|
| | PG | 2-HEMA | PEG400 | BB | filler | filler-1 | filler-2 | silica |
| Example 11 | | | 100.0 | | 124.8 | | | 11.6 |
| Example 12 | | | 84.9 | 51.1 | 124.8 | | | 11.6 |
| Example 13 | | | 70.0 | 30.0 | 124.8 | | | 11.6 |
| Example 14 | | | 65.0 | 35.0 | | 166.1 | | 11.7 |
| Example 15 | | | 59.9 | 40.1 | | 183.2 | | 11.8 |
| Example 16 | | | 54.9 | 45.1 | | 183.2 | | 11.8 |
| Example 17 | | | 50.0 | 50.0 | | 191.5 | | 11.5 |
| Example 18 | | | 44.8 | 55.2 | | 191.5 | | 11.5 |
| Example 19 | | | 40.0 | 60.0 | | 191.5 | | 11.5 |
| Comp. Ex. 8 | 100.0 | | | | 166.3 | | | 9.9 |
| Comp. Ex. 9 | | 100.0 | | | 158.6 | | | 11.6 |
| Comp. Ex. 10 | | | 20.1 | 79.9 | | | 208.0 | 11.5 |
| Comp. Ex. 11 | | | 10.2 | 89.8 | | | 208.0 | 11.5 |
| Comp. Ex. 12 | | | | 100.0 | | | 208.0 | 11.5 |

TABLE 3
Results of the evaluation of dental tone match checking materials (pastes)

| | | | | number of | | |
|---|---|---|---|---|---|---|
| | | | | individuals | | number of individuals |
| | | | | rendering a | | rendering a judgment |
| | | | ΔE* (upper | judgment of no | ΔE* (upper | of no color |
| | | | test | color difference | test | difference in visual |
| | refractive | | specimen: | in visual checking | specimen: T- | checking by 10 |
| | index | n₁ − n₀ | T) | by 10 individuals | Glass) | individuals |
| Example 11 | 1.469 | −0.037 | 0.327 | 9 individuals | 0.490 | 9 individuals |
| Example 12 | 1.478 | −0.028 | 0.248 | 10 individuals | 0.469 | 9 individuals |
| Example 13 | 1.487 | −0.019 | 0.201 | 10 individuals | 0.296 | 10 individuals |
| Example 14 | 1.496 | −0.010 | 0.206 | 10 individuals | 0.251 | 10 individuals |
| Example 15 | 1.500 | −0.006 | 0.215 | 10 individuals | 0.072 | 10 individuals |
| Example 16 | 1.503 | −0.003 | 0.198 | 10 individuals | 0.160 | 9 individuals |
| Example 17 | 1.505 | −0.001 | 0.105 | 10 individuals | 0.093 | 10 individuals |
| Example 18 | 1.509 | 0.003 | 0.083 | 10 individuals | 0.200 | 10 individuals |
| Example 19 | 1.511 | 0.005 | 0.281 | 10 individuals | 0.465 | 9 individuals |
| Comp. Ex. 8 | 1.446 | −0.060 | 0.607 | 2 individuals | 1.737 | 0 individuals |
| Comp. Ex. 9 | 1.462 | −0.044 | 0.519 | 1 individual | 0.833 | 0 individuals |
| Comp. Ex. 10 | 1.530 | 0.024 | 1.297 | 0 individuals | 0.525 | 1 individual |
| Comp. Ex. 11 | 1.535 | 0.029 | 1.915 | 0 individuals | 0.937 | 0 individuals |
| Comp. Ex. 12 | 1.542 | 0.036 | 3.174 | 0 individuals | 1.981 | 0 individuals |

1. A color test composition for dental treatment, wherein a difference (n₁−n₀) between the refractive index n₁ of the color test composition and a refractive index n₀ of a cured product obtained from a dental cement whose color corresponds to that of the color test composition is in a range from −0.040 to +0.020.

2. The color test composition for dental treatment according to claim 1, comprising (1) at least one hydrophilic component selected from (a) glycerin and (b) polyethylene glycol and (2) (c) a compound having at least one aromatic group.

3. The color test composition for dental treatment according to claim 2, comprising a total of 100 weight parts comprising 40 to 95 weight parts of the hydrophilic component and 5 to 60 weight parts of the compound.

4. The color test composition for dental treatment according to claim 2, wherein (c) the compound having at least one aromatic group is at least one selected from aromatic carboxylic acids, esters of aromatic carboxylic acids, and salts of aromatic carboxylic acids.

5. The color test composition for dental treatment according to claim 2, further comprising 1 to 50 weight parts of a (d) polymerizable monomer that contains at least one hydroxyl group, per 100 weight parts of the total of the hydrophilic component and the compound.

6. The color test composition for dental treatment according to claim 5, wherein the (d) polymerizable monomer that contains at least one hydroxyl group is 2-hydroxyethyl(meth)acrylate.

7. The color test composition for dental treatment according to claim 2, further comprising 1 to 30 weight parts of a (e) finely particulate filler having an average particle diameter of not more than 0.1 μm, per 100 weight parts of the total of the hydrophilic component and the compound.

8. The color test composition for dental treatment according to claim 2, further comprising 40 to 240 weight parts of (b a coarsely particulate filler having an average particle diameter of 0.5 to 20 μm, per 100 weight parts of the total of the hydrophilic component and the compound.

9. The color test composition for dental treatment according to claim 2, further comprising a pigment other than the finely particulate filler and coarsely particulate filter.

10. A dental prosthetic restoration kit, containing at least one set comprising the color test composition for dental treatment according to claim 1 paired with a dental cement whose color corresponds to that of the color test composition.

11. A dental tone match evaluation method of checking the suitability of the tone of a cured product obtained from a dental cement whose color corresponds to that of a color test composition for dental treatment, by, prior to bonding a dental prosthesis to an anchor tooth with the dental cement, temporarily mounting the dental prosthesis or a temporary restoration therefor on the anchor tooth using the color test composition and inspecting this temporarily mounted condition,
wherein the difference (n₁−n₀) between the refractive index n₁ of the color test composition and the refractive index n₀ of the cured product obtained from the dental cement is in a range from −0.040 to +0.020.

12. The color test composition for dental treatment according to claim 3, wherein (c) the compound having at least one aromatic group is at least one selected from aromatic carboxylic acids, esters of aromatic carboxylic acids, and salts of aromatic carboxylic acids.
